(19) United States
(12) Patent Application Publication
(10) Pub. No.: US 2006/0026028 A1
(43) Pub. Date: Feb. 2, 2006

(54) A Method of Profiting by Inventing

(76) Inventor: Andrew F. Knight, Canon, GA (US)

Correspondence Address: ANDREW F. KNIGHT, 2770 AIRLINE GOLDMINE RD., CANON, GA, 30520, US

(21) Appl. No.: 11/160,938

(22) Filed: Jul. 15, 2005

Related U.S. Application Data
(60) Provisional application No. 60/592,976, filed on Jul. 31, 2004.

(51) Int. Cl. G06Q 99/00

(52) U.S. Cl. 705/1

(57) ABSTRACT

A method of doing business includes: ascertaining an invention record; identifying an inventor; estimating a cost to breaking the invention record; indicating to a sponsor that the inventor intends to invent sufficiently many inventions to break the invention record; providing evidence to the sponsor that the inventor is capable of inventing sufficiently many inventions to break the invention record; and inciting the sponsor to pay for at least a portion of the cost at least in part by offering to the sponsor at least one of: at least a portion of royalty rights relating to the inventions; and at least a portion of media rights relating to the inventor.

The present application claims priority to U.S. Provisional Patent Application No. 60/592,976, filed Jul. 31, 2004.

### BACKGROUND

Inventors—the true creators of the world's wealth—are ironically not the primary possessors of the massive wealth they create. In a nutshell, even some of the world's most prolific inventors have modest incomes and modest standards of living. In large part, this is because most inventors work for large corporations, to whom they have an obligation to assign rights to all of their inventions. While the American patent system loudly proclaims its desire to motivate inventors with a 20-year exclusive ownership interest in their inventions, most inventors actually take home merely their salary and an occasional thousand-dollar patent bonus. Thus, potentially the largest source of untapped inventive power is within the self-employed and those who do not have a pre-existing obligation to assign another the rights to their creations—in other words, those who must foot the entire bill of developing and patenting an invention themselves. Thanks to a poisonous debt-based economy in which virtually all new money is issued as a fundamentally nonrepayable loan secured by real assets, insolvency among even the country's wealthiest increases as they struggle to keep their paper net worth positive. Even the most frugal and hard-working inventor likely would have difficulty in footing a $10,000 bill for a patent application. Thus, many present inventions go unexploited and unpublicized, and many future inventions are squashed by the prospect of diminished or zero returns.

There is a need for a method of profiting by inventing by extremely prolific, but otherwise poor or modest, inventors.

### SUMMARY OF THE INVENTION

The present invention aims to solve at least one of these and other problems.

In one embodiment, a method of doing business comprises performing or inciting another to perform at least one of steps a)-f): a) ascertaining an invention record; b) identifying an inventor; c) estimating a cost to breaking the invention record; d) indicating to a sponsor that the inventor intends to invent sufficiently many inventions to break the invention record; e) providing evidence to the sponsor that the inventor is capable of inventing sufficiently many inventions to break the invention record; and f) inciting the sponsor to pay for at least a portion of the cost at least in part by offering to the sponsor at least one of: at least a portion of royalty rights relating to the inventions; and at least a portion of media rights relating to the inventor, wherein steps a)-f) are performed.

In one aspect, the method further comprises performing or inciting another to perform at least one of steps k)-l): k) soliciting the creation of a profit-producing medium based at least in part on the inventor breaking the invention record; and l) cooperating to create the medium, wherein steps k)-l) are performed.

In one aspect, the evidence comprises evidence that the inventor has already invented at least twenty inventions. In one aspect, the cost comprises statutory fees for application submission, prosecution, and issuance. In one aspect, the cost comprises compensation for drafting patent applications.

In one aspect, step c) comprises: estimating a number of at least one of issued patents and submitted patent applications necessary to break the invention record; and estimating a cost to at least one of prepare, submit, and obtain the number.

In one aspect, the method further comprises assembling a patent application drafting team, the assembling comprising at least one of steps g)-j): g) providing at least one registered patent agent or registered patent attorney; h) providing a plurality of workers, each of the workers at least one of non-registered and substantially inexperienced at drafting patent applications; i) teaching the plurality of workers how to draft patent applications; and j) inciting the at least one registered patent agent or registered patent attorney to review and submit patent applications drafted by the plurality of workers, wherein steps g)-j) are performed.

In one aspect, the method further comprises compensating the plurality of workers with at least one of: at least a portion of royalty rights relating to the number; and at least a portion of media rights relating to the inventor. In one aspect, the method further comprises compensating the at least one registered patent agent or registered patent attorney with at least one of: at least a portion of royalty rights relating to the number; and at least a portion of media rights relating to the inventor. In one aspect, the method further comprises compensating the inventor with at least one of: at least a portion of royalty rights relating to the number; and at least a portion of media rights relating to the inventor.

In one aspect, the invention record is a prolificness in a period of time, the period of time between approximately one month and approximately two years. In one aspect, the invention record is a prolificness in a period of approximately one year. In one aspect, the invention record is a largest number of patent applications submitted. In one aspect, the invention record is a largest number of patents received.

In one aspect, step c) comprises: estimating a patent allowance percentage; estimating a number of submitted patent applications necessary to break the invention record based at least in part on the patent allowance percentage; and estimating a cost to at least one of prepare and submit the number.

In one aspect, the invention record is a largest number of U.S. patent applications, ultimately issuing as patents, solely submitted by a person. In one aspect, the person is a U.S. inventor. In one aspect, the largest number is a largest number in a period of time, the period of time between approximately one month and approximately two years.

In another embodiment, a method of doing business comprises performing or inciting another to perform at least one of steps a)-c): a) ascertaining an invention record; b) announcing a competition to break the invention record; and c) offering to reward a winner of the competition in exchange for at least one of: at least a portion of royalty rights relating to inventions of the winner; and at least a portion of media rights relating to the winner, wherein steps a)-c) are performed.

In one aspect, the method further comprises performing or inciting another to perform at least one of steps d)-g): d) identifying an inventor; e) receiving evidence that the inventor is capable of inventing sufficiently many inventions to break the invention record; f) estimating a cost to breaking the invention record; and g) paying for at least a portion of the cost at least partly in exchange for at least one of: at least a portion of royalty rights relating to inventions of the inventor; and at least a portion of media rights relating to the inventor, wherein steps d)-g) are performed.

In one aspect, the method further comprises creating of a profit-producing medium based at least in part on the inventor breaking the invention record. The evidence may comprise evidence that the inventor has already invented at least twenty inventions.

In one aspect, the method further comprises assembling a patent application drafting team, the assembling comprising at least one of steps g)-j): g) providing at least one registered patent agent or registered patent attorney; h) providing a plurality of workers, each of the workers at least one of non-registered and substantially inexperienced at drafting patent applications; i) teaching the plurality of workers how to draft patent applications; and j) inciting the at least one registered patent agent or registered patent attorney to review and submit patent applications drafted by the plurality of workers, wherein steps g)-j) are performed.

In one aspect, the invention record is a prolificness in a period of approximately one year. In one aspect, the invention record is a largest number of U.S. patent applications, ultimately issuing as patents, solely submitted by a person. In one aspect, the person is a U.S. inventor.

In one aspect, the method further comprises performing or inciting another to perform at least one of steps d)-g): d) identifying a plurality of inventors; e) receiving evidence that each of the plurality of inventors is capable of inventing sufficiently many inventions to break the invention record; f) estimating a cost to breaking the invention record; and g) for each of the plurality of inventors, paying for at least a portion of the cost at least partly in exchange for at least one of: at least a portion of royalty rights relating to inventions of the each of the plurality of inventors; and at least a portion of media rights relating to the each of the plurality of inventors, wherein steps d)-g) are performed.

### DETAILED DESCRIPTION

In the following description, the use of “a,” “an,” or “the” can refer to the plural. All examples given are for clarification only, and are not intended to limit the scope of the invention.

In a preferred embodiment, an inventor is able to raise capital for pursuing patent protection on his various inventions by selling royalty rights to future issued patents, as well as media rights. He may add value to the media rights by doing something no one before has done, such as break some record dealing with invention. The doing of anything new, interesting, unique, or unusual is almost always interesting to the populace, and thus the right to cover the event in the form of a commercial, an advertisement, a TV special, a book, a movie, a billboard, and so forth, has value.

In a preferred embodiment, the inventor breaks an invention record as his sort of valuable-media-right “claim to fame.” Any invention-related record is within the scope of the present invention. For example, the record may deal with the largest number of patent applications submitted by a person in total, or within a certain time period, such as within about a month, three months, six months, a year, two years, etc. Further, the record may be limited to patent applications on inventions for which the inventor was the sole inventor. For example, an invention record in which Inventor A submits 100 patent applications in a year, on all of which he is but one of several joint inventors, is substantively different from an invention record in which Inventor B submits 50 patent applications in a year, on all of which she is named the sole inventor. Both represent distinct invention records that are within the scope of the present invention.

Further, an invention record in which Inventor A submits 100 patent applications, only 50 of which ever actually mature into issued patents, is substantively different from an invention record in which Inventor B submits 80 patent applications, 70 of which mature into issued patents. Both represent distinct invention records that are within the scope of the present invention. Further, these inventors A and B might have actually invented or conceived of their respective inventions, or executed the resulting patent applications, at substantially different times as the submission of those applications.

Further, an invention record in which Inventor A submits 100 patent applications, 50 of which claim variations on a first fundamentally common invention or technology and 50 of which claim variations on a second fundamentally common invention or technology, is substantively different from an invention record in which Inventor B submits 20 patent applications on 20 entirely different inventions dealing with entirely different technologies.

Essentially, an invention record is a record dealing with inventing, such that the phrasing of the record criteria determines its difficulty to match or break, as well as the interest the populace is likely to take. For example, an inventor who conceives of an invention on Jul. 27, 2004 at 4:47 pm might achieve the record of “the inventor having conceived of the largest number of inventions on Jul. 27, 2004 at 4:47 pm” if no one else conceived of an invention at precisely that minute. While this particular record cannot be broken (as the time has already passed 4:47 pm), the general record of conceiving of an invention in a minute's time is so easy to match as to render the “record” unspectacular and uninteresting. Alternatively, if the length of time is substantially increased, say to a period of one year, the record becomes more interesting, because the difficulty of equaling or stealing the title of “the inventor having conceived of the largest number of inventions in a one-year period” is far, far greater.

Any record criteria is within the scope of the present invention. Examples include: number of issued patents, number of patent applications, number of patent applications that ultimately mature into patents, number of inventions, type of patents (e.g., utility vs. design), number of licensed inventions or patents, value of licensed patents or inventions, time periods (e.g., in which the number of invention conceptions, submitted patent applications, issued patents, etc., is counted), nationality of the inventor, loneness of the inventor, relations and similarities among the patents/applications/inventions, country of submission of applications or issuance of patents, personal features of the inventor (e.g., race, ethnicity, gender, religion, physical and mental illnesses or weaknesses, and so forth), conditions under which the inventor invented (e.g., holding down another unrelated job simultaneously, assuming the responsibility of drafting and prosecuting his own patent applications, perpetually hiding from authorities due to laundering drug money in eastern Europe, and so forth), and on and on.

An example record utilizing several of the above mentioned criteria will be offered for clarity. Assume, for example, that the largest number of U.S. utility patent applications invented, drafted, paid for, and submitted within a one-year period solely by an American inventor, who simultaneously attended law school full time, is 20. This invention record could be explicitly stated, an another inventor attempt to break the record. Typically, the more words or criteria in the record, the less interesting and impressive, because the record breaker comes from a smaller available pool of contenders. In the above example, all contenders must be full-time law students, as well as have sufficient resources readily available to self pay for all patent application submissions. If such criteria are included, the pool of possible contenders might, e.g., decrease by a factor of 100, thus easing the breaking of the record by a factor of 100. Generally, the fewer the words, the broader the pool of available contenders, and the more interesting and impressive the breaking of the record.

For example, Thomas Edison holds the record for the American inventor having the most U.S. utility patents. The record is impressive and interesting in part because the number of words—more specifically, the number and type of criteria—are few. “American” is not unduly narrow, because there are almost 300 million Americans. “U.S.” is not unduly narrow, because the U.S. patent system is the strongest and provides the most patents in the world. “Utility” is not unduly narrow, because utility patents are essentially “ordinary” patents, as commonly understood. However, a record for the Bermudian having the most Canadian industrial design registrations might not be nearly as interesting or impressive.

While a record for the American inventor having the most U.S. utility patents is broad and impressive, such a record was achieved over the course of Edison's life; thus, such a record is not likely to be broken in a short period of time. A more short-term record would restrict the number of patents to a short time, such as a year. However, a patent applicant typically has little or no control at the rate of issuance by the U.S. Patent and Trademark Office, which may range from one to five years per application. Thus, Inventor A could, theoretically, submit 20 patent applications per year for five years, and, by luck of the draw, obtain 100 issued patents in the same year. Inventor B, who is clearly more prolific-per-time than Inventor A, may submit 100 patent applications in the first year, but obtain only 20 issued patents per year for five years. Thus, a time-restricted record should, in a preferred embodiment, focus on dates of conceptions of inventions, executions of patent applications, and/or submissions of patent applications, instead of the dates of issuances. However, this focus should be tempered by the consideration that patent applications, by themselves, don't necessarily indicate an inventive step or the potential for an issued patent. Thus, a more appropriate, impressive record might be “the inventor who solely submitted the largest number of U.S. utility patent applications, ultimately issuing as patents, over a period of one year.” Any of the above mentioned criteria, and others known in the art, are within the scope of the invention, and may be “mixed and matched” for form an invention record that is interesting, impressive, and achievable.

In a preferred embodiment, an invention record is decided upon and then ascertained, to obtain the actual data or statistics for the invention record. For example, if the aforementioned invention record is decided upon, then the actual record (the inventor who solely submitted the largest number of U.S. utility patent applications, ultimately issuing as patents, over a period of one year) is ascertained. Assume, for example, that the record is 115. Next, an inventor is identified to break the record. The inventor (or a representative of the inventor) may indicate to a potential sponsor that the inventor intends to break the record, for example, by submitting sufficiently many new patent applications in the course of a year such that the expected number of issued patents of those submitted patent applications exceeds 115. For example, the patent agent or attorney or patent application drafting team for the inventor's inventions may have a history of a 75% allowance rate—i.e., 75% of the applications drafted and prosecuted by the patent agent or attorney ultimately issue as patents. In that case, if the inventor aims and intends to invent 160 inventions over the course of the year, on which the patent agent or attorney drafts and submits patent applications, then the inventor breaking the invention record is relatively likely, because 75% of 160 applications is 120, which is greater than the record of 115. Thus, in one embodiment, where the invention record is a number of issued patents (e.g., in a one-year period), the method includes estimating a patent allowance percentage, such as 75% or 85% or 90%, and estimating the number of submitted patent applications necessary to break the invention record. The costs would then include the costs of inventing and submitting this number of patent applications, even though less than 100% may issued into patents.

Further, the method may include providing evidence to the sponsor indicating that the inventor is capable of inventing sufficiently many inventions to break the invention record. Such evidence may include: a past record of obtaining patents (e.g., being a named or sole inventor on at least 10, at least 20, at least 50, or at least 100 patents), a past record of inventing (e.g., being a joint or sole inventor of at least 10, at least 20, at least 50, or at least 100 inventions), a past record of licensing inventions (measured, e.g., in number of patents or inventions licensed, such as at least 3, at least 5, or at least 10 inventions and/or patents, or profit obtained from licensing patents or inventions, such as at least $100K, at least $250K, at least $ 500K, or at least $1 M), any of the above-mentioned records with respect to a limited time period (e.g., a past record of inventing at least 20 inventions over the course of a year, etc.), etc. Another example of such evidence is a sort of “test” that does not include a past history of inventing or patenting. For example, the prospective inventor (or inventors, in the case of a competition among many contenders) may be unleashed in a toy store to invent various new toys and/or improvements/variations on the existing toys. An inventor that can conceive of 5 or 10 valuable, potentially patentable new toys or variations or improvements on existing toys is likely to be able to break an invention record of “the inventor who solely submitted the largest number of U.S. utility patent applications, ultimately issuing as patents, over a period of one year.”

There are several costs to obtaining valuable patents, including the costs of inventing (e.g., placing the inventor in an invention-conducive environment, providing the tools, building blocks, etc., to allow construction of prototypes, etc.), the cost of prior art or novelty searches, the costs of drafting and prosecuting patent applications, the statutory fees for application, publication, issue, maintenance, etc., the costs of licensing (e.g., business relations, building and operating working prototypes, drafting convincing business plans, etc.), and other costs. The only of these costs that is truly mandatory is the statutory fees for obtaining patents, particularly where the costs of drafting and prosecuting patent applications can be paid for on “contingency” (i.e., a portion of future royalty rights on issued patents). Thus, in a preferred embodiment, the method further includes soliciting the sponsor to pay for at least a portion of these costs (preferably at least the statutory fees, and preferably also at least the drafting and prosecution costs) in exchange for some of the booty of breaking the invention record and/or the resulting issued patents. In a preferred embodiment, the solicitor should not use the word “booty” without wearing an eye patch and a parrot on his shoulder.

At least two valuable kinds of rights will emerge from this method: patent rights (which also imply royalty rights based on the right to enforce the patent rights); and media rights relating to the record-breaking inventor, his/her inventions, and/or the process of breaking the record.

Regarding the patent rights, assume that the inventor(s) indicates his intention to break the invention record (e.g., the previously mentioned record, which record may be at 115) and provides evidence to indicate his ability to break the record. Assume that he ultimately submits 160 patent applications, of which he expects 120 to ultimately issue as patents, thus breaking the invention record. Assuming that the expected value of 120 well-drafted, broadly claimed patents is on the order of $20K/each, the 120 patents would collectively have a value of $2.4M. As understood by one of ordinarily skill in the art, expected values of patents are typically based on a large collection of patents, recognizing that only a very small percentage of patents are ultimately licensed or used for financial gain, but that this small percentage might average profits of over $1 M each (thus skewing the average value of each patent to around $20K/each). Thus, at least part of the consideration offered to the sponsor in exchange for footing at least part of the above-mentioned costs may be a portion of the royalty rights (via patent rights resulting from submitted patent applications) relating to the inventor's inventions that he invented while attempting to break the invention record. The “portion” of the royalty rights may be a percentage of royalties (such as at least 10%, at least 20%, at least 30%, at least 50%, at least 70%, etc.), or any other portion (such as a discrete quantity, such as “$100,000 if at least $1 M in profits are collected,” etc.). As an example, the sponsor may be incited to foot $500K of the above-mentioned costs in exchange for receiving 50% of all royalties of the resulting issued patents—which, if the patents were valued at $2.4M, would be worth $1.2M . . . a nice return-on-investment.

Alternatively or in addition, the sponsor may be incited to foot some of the costs by being offered a portion of the media rights. All kinds of media rights known in the art are within the scope of the present invention. For example, if the inventor is in the process of, or succeeds in, breaking the invention record, particularly where the invention record is broad, challenging, and interesting, the populace will be willing to pay to observe such a record being broken, in the form of magazine or newspaper articles, commercials, television specials, movies, books, billboard or other advertising, radio or television news programs, and so forth, all of which consumers ultimately pay for. A simple example of such a media right is the right of the inventor to protect his personality/likeness and to select which product and/or company he will endorse. Being, for example, the world's most prolific yearlong inventor (i.e., the inventor who solely submitted the largest number of U.S. utility patent applications, ultimately issuing as patents, over a period of one year) is a personality that consumers will pay to see, particularly if the inventor is himself an interesting character. Further, the process of breaking the invention record is also something consumers will pay to see, particularly if the invention record is interesting and challenging, and if the process is especially unique, energetic, exciting, and fun. $Millions are paid to basketball players to advertise or endorse sports shoes and products and $millions are paid to celebrities who have lost weight to endorse various diet products, programs, and methods. Yet, while the high-tech sector of the world's economy is large and growing, there is a vast shortage of persuasive endorsement opportunities. A person who, e.g., single-handedly breaks a long-standing, impressive invention record will become a valuable endorser, and/or creator of profit-producing media such as commercials, TV specials, books, and so forth.

In one embodiment, the method includes soliciting the creation of a profit-producing medium based at least in part on the inventor breaking the invention record, and subsequently cooperating to create the medium. For example, the inventor may offer to the potential sponsor the right to videotape the process of breaking the invention record (e.g., including live footage of the inventor creating working prototypes, the inventor's interaction with his patent application drafting team, the inventor explaining his thought processes and identifying problems needing inventive solutions, and so forth). The video may then be edited into a 30-minute TV special, which may be profit-producing if the sponsor succeeds in selling the rights to the TV special to a TV or cable channel, etc.

The ways in which one may profit from the media rights of an inventor breaking an interesting, challenging invention record are virtually limitless and within the scope of the present invention. Ultimately, the sponsor may be incited to foot at least part of the costs of breaking the invention record by being offered at least a portion of the media rights related to the inventor and/or his breaking of the invention record. For example, the sponsor may be offered all media rights, including the right to videotape the record-breaking process and sell the resulting medium to another for profit, as well as the right to exploit the inventor's endorsement of a product or company, as well as the right to collect profits on television, radio, magazine, or newspaper interviews of the inventor and/or his patent application drafting team. The media rights may extend beyond just the inventor, and may include media rights relating to the patent application drafting team, the sponsor itself, and/or anyone else involved with breaking the invention record. Alternatively, the media rights offered to the sponsor may be limited, or may be a portion (e.g., a percentage, such as at least 10%, at least 20%, at least 30%, at least 50%, at least 70%, etc.) of all media rights and their resulting profits, and so forth. Succinctly, breaking an interesting, fascinating, challenging invention record may give rise to protectable, valuable media rights, all or part of which may be used as leverage (possibly in addition to all or part of the royalty rights arising from future issued patents) to obtain sponsorship for at least a portion of the costs involved in breaking the invention record.

In another embodiment, the costs to breaking the invention record are further reduced by employing a low-cost, efficient patent application drafting team. For example, the method may further comprise providing at least one registered patent agent or registered patent attorney, preferably very experienced in drafting high-quality patent applications, and providing a plurality of workers, each of the workers either non-registered with the U.S. Patent and Trademark Office, and/or substantially inexperienced. For example, a substantially inexperienced patent agent/attorney may have less than one year experience drafting patent applications. The method may further include teaching the plurality of workers how to draft patent applications, and subsequently inciting the at least one patent agent/attorney to review, revise, and submit the patent applications drafted by the plurality of workers. Drafting valuable, well-claimed patent applications is a skill that can be learned by very intelligent people of many fields. Neither a strong technical expertise nor a plethora of degrees from Ivy League schools is necessary. However, creativity, an analytical mind, a propensity and skill for learning how things work, and a mastery of writing are required. Such qualifications can be and have often been met by employees who happily labor at a salary substantially lower than that of a typical patent attorney. Thus, while the bulk of patent applications can be drafted by nonlegal professionals, the applications can be reviewed for legal aspects, technical content, thoroughness, and claim quality by the at least one (preferably experienced) registered patent agent/attorney.

The inventor, the at least one registered patent agent/attorney and the plurality of workers may be compensated at least in part in money, in royalty rights to future issued patents, and/or in media rights, as well as any other form of compensation. For example, if the inventor is paid entirely in a share of the royalty rights to future issued patents and/or a share of the media rights, and if the inventor offers to pay the at least one registered patent agent/attorney and the plurality of workers mostly or significantly in a share of the royalty rights to future issued patents and/or a share of the media rights, then the total out-of-pocket costs of breaking the invention record (and thus the costs, or a portion of which, the sponsor must be incited to pay in exchange for other benefits discussed) may be minimized. Further, compensating those involved in this way is likely to improve the quality of the product (i.e., the issued patents and the media rights) because the workers, agent/attorney, etc., will have a direct stake in the product.

In one embodiment, the method is performed at least in large part by the inventor, the registered patent agent/attorney, or both. For example, a prolific, capable inventor may approach a registered patent agent/attorney, in search of capital or funding to obtain many patents. At least one of the inventor and agent/attorney may then decide on an invention record to break, and then ascertain what the actual invention record actually is. If the inventor does not believe that she is capable of breaking that particular record, another invention record can be decided upon and the actual record ascertained, keeping in mind that the broader, more interesting, more difficult the invention record is, the more easily a sponsor will be incited or convinced to fund at least part of the project. The agent/attorney may assemble a low-cost, highly efficient patent application drafting team, and the costs of breaking the invention record may be estimated. Then, the inventor and agent/attorney (preferably but not necessarily as a team) approach a potential sponsor, and the inventor indicates an intention to break the invention record, and provides evidence that she is capable of inventing sufficiently to break the record. They may then offer either or both of some royalty rights to future issued patents and media rights, in exchange for the sponsor paying for at least part of the costs of breaking the record. After funding is available, the inventor proceeds to invent in an effort to break the invention record, and the patent application drafting (and/or prosecuting) team works with the inventor to draft patent applications on the various inventions. The process and/or result may be covered by the media at a profit to those involved, in the form of media rights. The ultimately issued patents may also profit those involved, in the form of licensing, royalty, or use rights, etc. Other rights and property interests that may arise from such a project, that are apparent to one of ordinary skill in the art, are within the scope of the present invention, and may be enjoyed by the inventor, the agent/attorney, the workers, and/or the sponsor.

In another embodiment, instead of an inventing/drafting team approaching a sponsor, a sponsor may approach various inventors. For example, a high-tech sponsor may have a need to “create” a new “celebrity” in the high-tech world as an endorser of its products/services. Alternatively or in addition, a company may desire to create a sort of “reality” television show dealing with creation, invention, and so forth. Thus, a company may decide upon and ascertain the actual record of an invention record. Then, the company may search for and identify an inventor who may potentially break the invention record. In doing so, it may be provided with evidence that the inventor is capable of inventing sufficiently many inventions to break the invention record, and the inventor may indicate to the company an intention to break the invention record. After estimating the costs of the inventor breaking the invention record, the company may then offer to pay at least a portion of the costs of breaking the invention record (preferably all of the statutory fees of the patent applications and issued patents, as well as the costs of drafting and prosecuting patent applications), in exchange for either or both of at least a portion of the media rights and a portion of the patent/royalty rights from future issued patents. Preferably the inventor is a charismatic, interesting, uplifting person who will create very valuable media rights by being someone that the populace admires, loves, and is in favor of . . . who the populace wants to “win” the race and break the invention record. The ongoing “reality” television show may bring in substantial profits and revenues by itself, not to mention the valuable future media rights to nonfiction accounts, books, interviews, endorsements, “true-story” movies, and so forth. This is on top of the actual value of the patents themselves. In another embodiment, the company may publicly announce that the resulting patents will all be donated to the public domain, free for use by anyone. Such an announcement may be so well received by the general public that the resulting increase in value of the media rights to the project (which may be called the Invention Marathon or the Patent Marathon) exceed the expected value of the patents that are promised to the public domain.

Next, instead of identifying a single inventor to potentially break the invention record, the company may announce and sponsor a competition among a plurality of potential inventor contenders to break the invention record. The company may offer a reward to the winner of the competition, whether or not the winner broke the invention record, or may reserve rewards only for the inventor(s) who break(s) the invention record. The company may also offer to the winner, the breaker(s) of the invention record, and/or all contenders at least a portion of the media rights generated and/or at least a portion of the royalty rights to future issued patents resulting from each contender's inventions. For example, the company might offer each contender 50% of the value of his issued patents, or may offer each contender a pro-rata of a 50% share of the collective value of all issued patents, or an equal share of a 50% share of the collective value of all issued patents. For example, if all contenders produced 1000 patents, which ultimately are licensed for $10M, and if Contender A produced 100 patents, while Contender B produced 150 patents, then Contender A would receive $500K while Contender B would received $750K, and so forth. The same may apply for any media rights collectively obtained. Any known way of compensating the inventor contenders, and at any percentage, is within the scope of the present invention. Of course, this generation so loves to be on television, and to do or endure so much for so little compensation (e.g., Fear Factor™), that the various inventor contenders may be willing to compete for a relatively small award (e.g., $1 M or less), with the “losers” taking home nothing, in exchange for assigning to the company all media rights and all patent/royalty rights, which would amount to a fantastic return-on-investment for any company.

For such a competition, the invention record should probably deal with a number of submitted patent applications in a time period (which may be based on an expected allowance percentage and a maximum number of patents received in such a time period, as previously discussed), as the media buzz and attention would long be over before even the first of the hundreds or thousands of applications issued as a patent. In other words, a contender may win the competition if he submits at least a minimum number of patent applications, even if ultimately the number of issued patents does not break the issued-patent-based invention record. Further, the company may provide its own patent application drafting and prosecuting team, which may subjectively evaluate each invention submitted by each inventor contender to determine whether the invention is sufficiently likely to issue as a patent if submitted to the USPTO. The “reality” television show may thus include not only the wacky, animated, interesting inventors in the process of inventing, it may also include commentary by snotty patent attorneys wearing bowties and speaking in thick English accents on the usefulness and/or patentability of each of the inventors' inventions. Much like the arrogant and ultra-critical commentary and decisions of the judges on American Idol™, the nation hangs on the words of the patent attorney as he decides whether or not a particular invention is sufficiently useful, new, and patentable to be worthy of a patent application. If so, the inventor gets another application to his credit, on his way to breaking the invention record. If not, the inventor is shown uttering profanity under his breath, and consumers throw popcorn at their televisions. It all adds up to some exciting, suspenseful, inventing fun that can generate $millions in media revenues.

Any and all of the features of the previously discussed embodiment (where the sponsor is approached) may be incorporated, where possible, into the above embodiment (where the sponsor approaches inventor(s) and/or announces an invention competition to which inventors apply). For example, in the case of the competition, at least some of the inventor applicants to the competition may be required to provide evidence of an ability to invent sufficiently many inventions to break the invention record. Of course, one or more of the chosen inventor contenders may be total crackpots with no real chance of breaking the invention record, provided primarily for comedy and consumer enjoyment.

Most of the embodiments described herein have represented simple versions for clarity of explanation. As understood by one of ordinary skill in the art, many of the features and/or aspects of the embodiments described herein may be “mixed and matched” to the extent physically possible to satisfy individual design requirements. These variations are merely examples, and do not limit the scope of the present invention. Any features described herein may be mixed and matched with other features to form embodiments not specifically described but within the scope of the present invention.

The present invention includes one or more of the steps discussed, as well as the causing or inciting or encouraging of another to perform one or more of the steps. For example, if a method comprises steps A, B, and C according to one embodiment of the present invention, then a method comprising performing or inciting another to perform one or more of steps A, B, and C, where A, B, and C are performed, includes the following scenarios as examples: a person performs A, B, and C; a person encourages another to perform steps A, B, and C; a person performs steps A and B and encourages another to perform step C; a person performs step A, pays a first person to perform step B, and causes a second person to perform step C; and so forth.

1-20. (canceled)

21. A method of executing a competition, comprising:
a) soliciting a plurality of inventor contenders to participate in a competition relating to inventions;
b) hosting the competition among the plurality of contenders;
c) publishing the competition;
d) offering a reward to a winner of the competition; and
e) profiting from either or both of: at least a portion of media rights relating to the competition; and at least a portion of royalty rights relating to an invention of the winner.

22. The method as claimed in claim 21, further comprising offering to pay at least a plurality of the plurality of contenders for at least a portion of costs associated with winning the competition.

23. The method as claimed in claim 21, further comprising offering a reward to a plurality of the plurality of contenders in exchange for both of: at least a portion of the media rights; and at least a portion of royalty rights relating to inventions of the plurality of the plurality of contenders.

24. The method as claimed in claim 21, further comprising offering a reward of approximately $1 million to at least one of the contenders.

25. The method as claimed in claim 21, further comprising providing footage of at least one of the contenders creating an invention prototype.

26. The method as claimed in claim 21, further comprising providing footage of at least one of the contenders explaining his thought processes regarding his invention.

27. The method as claimed in claim 21, further comprising providing commentary regarding usefulness of an invention of at least one of the contenders.

28. The method as claimed in claim 21, further comprising receiving evidence that each of a plurality of the plurality of contenders is capable of winning the competition.

29. The method as claimed in claim 21, further comprising performing at least two of steps f)-h):
f) ascertaining an invention record;
g) soliciting a plurality of inventor contenders capable of breaking the invention record to participate in the competition; and
h) recording a contender's expressed intention to break the invention record.

30. The method as claimed in claim 21, wherein at least a first inventor contender is solicited to participate in the competition: because the first inventor contender has substantially no chance of winning the competition; and to provide for comedy.

31. The method as claimed in claim 21, wherein at least a second inventor contender is solicited to participate in the competition at least in part because of a character of the second inventor contender.

32. The method as claimed in claim 21, wherein the competition is nationally televised.

33. The method as claimed in claim 21, further comprising causing the winner to become an inventor celebrity capable of endorsing products and services for profit.

34. The method as claimed in claim 21, wherein step e) comprises profiting from both of: at least a portion of media rights relating to the competition; and at least a portion of royalty rights relating to an invention of the winner.

35. The method as claimed in claim 34, wherein the at least a portion of royalty rights comprises at least a portion of patent rights.

36. A method of executing a competition, comprising:
a) soliciting a plurality of inventor contenders to participate in a competition relating to inventions;
b) receiving evidence that each of a plurality of the plurality of contenders is capable of winning the competition;
c) hosting the competition among the plurality of contenders;
d) publishing the competition;
e) offering a reward to a winner of the competition;
f) profiting from both of: at least a portion of media rights relating to the competition; and at least a portion of royalty rights relating to an invention of the winner; and
g) offering a reward to a plurality of the plurality of contenders in exchange for either or both of: at least a portion of the media rights; and at least a portion of royalty rights relating to inventions of the plurality of the plurality of contenders.

37. The method as claimed in claim 36, wherein the method further comprises offering a reward of approximately $1 million to at least one of the contenders.

38. The method as claimed in claim 36, wherein the method further comprises providing footage of at least one of the contenders creating an invention prototype.

39. A method of executing a competition, comprising:
a) soliciting a plurality of inventor contenders to participate in a competition relating to inventions;
b) hosting the competition among the plurality of contenders;
c) publishing the competition;
d) offering a reward to a winner of the competition;
e) profiting from both of: at least a portion of media rights relating to the competition; and at least a portion of royalty rights relating to an invention of the winner; and
f) offering to pay at least a plurality of the plurality of contenders for at least a portion of costs associated with winning the competition.

40. The method as claimed in claim 39, wherein the method further comprises providing footage of at least one of the contenders creating an invention prototype.
